(19) United States
(12) Patent Application Publication
(10) Pub. No.: US 2023/0105914 A1
(43) Pub. Date: Apr. 6, 2023

(54) FIXED ANGLE RATCHET ADAPTER

(71) Applicant: Jason White, Fowlerville, MI (US)

(72) Inventor: Jason White, Fowlerville, MI (US)

(21) Appl. No.: 17/953,890

(22) Filed: Sep. 27, 2022

Related U.S. Application Data
(60) Provisional application No. 63/230,814, filed on Oct. 5, 2021.

(51) Int. Cl. B25B 13/48

(52) U.S. Cl. CPC B25B 13/481; B25B 23/0035

(57) ABSTRACT

A fixed-angle ratchet adapter that uses gears to change the rotation angle for a ratchet or impact driver. One variation is meant to be used at right angles and another variation is meant to be used at 45 degree angles with either used on its own with a ratchet or impact driver or used in concert with various universal joints currently on the market to improve functionality.

### CROSS REFERENCE TO RELATED APPLICATIONS

This application claims priority to U.S. Provisional Patent Application Serial Number 63/230,814, filed on Oct. 5, 2021, the entire disclosure of which is hereby incorporated by reference and relied upon.

### FIELD OF THE INVENTION

This invention relates to universal joint attachments for ratchets for removing or inserting bolts, nuts, and other types of rotary fasteners. The device is meant to assist the user with rotary fasteners at various angles in tight spots that are hard to reach with a ratchet and extension alone.

### BACKGROUND OF THE INVENTION

Rotary fasteners, such as bolts, nuts, screws, or other rotary fasteners, having a threaded end for attaching two-piece parts together have many applications, for example, in the assembly of automobile components. For example, bolts or nuts typically have a hexagonal head that may be used to tighten or loosen the fastener with a toll such as a wrench, for example, a crescent or adjustable wrench. Such fasteners may also be tightened or loosened with the assistance of sockets that fit over the head and has an aperture at an opposite side for receiving a drive shaft of a hand wrench or a ratchet or impact driver.

However, in some applications the fastener may be located in a hard-to-reach area in that cannot easily be reached with a standard tool (even with an extension adapter). One attempt to solve this problem is the universal joint socket also called the swivel joint socket. The problem with these sockets is their propensity to wear out over time and the individual pieces of the part become loose and difficult to position when removing a nut or bolt, especially when working in a tight space. Also, because of their inherent design, universal joints tend to lose the ability to work effectively as the angle of use increases.

The present invention is aimed at one or more of the problems set forth above.

### BRIEF SUMMARY OF THE INVENTION

The present invention provides a fixed-angle adapter with the ability to transfer rotational force 90 degrees at higher forces in tight spaces while doing automotive work, construction, home maintenance, and any other area where ratchets and impact drivers are used. The fixed-angle adapted utilizes gears to change the rotation angle, for a ratchet or impact driver that is used mainly for automotive work. With other attachments, the fixed-angle adapted has possible applications in other industries as well. The fixed-angle adapter may be provided in different variations, e.g., sizes and at different angles, for example 45 degrees and 90 degrees. The fixed-adapter of the present invention may be used with different tools, such as a ratchet wrench, an impact driver and may be used in concert with various universal joints currently on the market to improve functionality.

In one aspect of the present invention, a fixed-angle adapter having a housing and first and second gears is provided. The housing includes a central portion and first and second end portions extending from opposite end of the central portion. The first end portion and the central portion define a first gear cavity. The first gear cavity defines a first gear axis. The second end portion and the central portion define a second gear cavity. The second gear cavity has a second gear axis. The first and second gear axis are planar with the second gear axis being at a predetermined angle relative to the first gear axis.

The first gear is located within the first gear cavity and is allowed to rotate about the first gear axis. The second gear is located within the second gear cavity and is allowed to rotate about the second gear axis. The first and second gears are intersecting such that rotation of one of the first and second gears about a respective one of the first and second gear axis results in rotation of the other one of the first and second gears about the other one of the first and second gear axis.

In another aspect of the present invention a fixed-angle adapter having a housing and first and second gears and first and second retention mechanisms is provided. The housing includes a central portion and first and second end portions extending from opposite end of the central portion. The first end portion and the central portion define a first gear cavity. The first gear cavity defines a first gear axis. The second end portion and the central portion define a second gear cavity. The second gear cavity has a second gear axis. The first and second gear axis are planar with the second gear axis being at a predetermined angle relative to the first gear axis.

The first gear is located within the first gear cavity and is allowed to rotate about the first gear axis. The second gear is located within the second gear cavity and is allowed to rotate about the second gear axis. The first and second gears are intersecting such that rotation of one of the first and second gears about a respective one of the first and second gear axis results in rotation of the other one of the first and second gears about the other one of the first and second gear axis.

Each of the first and second gears includes a shaft and a gear section. The gear section of each of the first and second gears is cone-shaped and includes a plurality of teeth located on the gear section. Each one of the shafts includes an outer end and a coupling mechanism affixed to the outer end. At least one of the coupling mechanisms on the shafts of the first and second gears is an aperture and the other one of the coupling mechanisms is an aperture or a drive stud. The first retention mechanism and the second retention mechanism are configured to retain the first gear and the second gear in the first and second cavities, respectively.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1A is a perspective view of a fixed-angle adapter, according to a first embodiment of the present invention.

FIG. 1B is an exploded view of the fixed-angle adapter of FIG. 1A.

FIG. 2A is a perspective view of a fixed-angle adapter, according to a second embodiment of the present invention.

FIG. 2B is a first cross-sectional view of the of the fixed-angle adapter of FIG. 2A.

FIG. 2C is a second perspective view of the of the fixed-angle adapter of FIG. 2A

FIG. 3A is a perspective view of a fixed-angle adapter, according to a third embodiment of the present invention.

FIG. 3B is a first cross-sectional view of the fixed-angle adapter of FIG. 3A.

FIG. 3C is a side view of the fixed-angle adapter of FIG. 3A.

FIG. 3D is a second cross-sectional view of the fixed-angle adapter of FIG. 3A.

FIG. 3E is a perspective view of an end cap of the fixed-angle adapter of FIG. 3A.

FIG. 4A is a perspective view of a fixed-angle adapter, according to a fourth embodiment of the present invention.

FIG. 4B is a first cross-sectional view of the fixed-angle adapter of FIG. 4A.

FIG. 4C is a second cross-sectional view of the fixed-angle adapter of FIG. 4A.

FIG. 5A is a perspective view of a fixed-angle adapter, according to a fifth embodiment of the present invention.

FIG. 5B is a first cross-sectional view of the fixed-angle adapter of FIG. 5A.

FIG. 5C is a second cross-sectional view of the fixed-angle adapter of FIG. 5A.

FIG. 6A is a perspective view of a fixed-angle adapter, according to a sixth embodiment of the present invention.

FIG. 6B is a first cross-sectional view of the fixed-angle adapter of FIG. 6A.

FIG. 6C is a second cross-sectional view of the fixed-angle adapter of FIG. 6A.

FIG. 7A is a side view of a first, or drive, gear of a fixed-angle adapter, according to an embodiment of the present invention.

FIG. 7B is a side view of a second, or driven, gear of a fixed-angle adapter, according to an embodiment of the present invention.

FIG. 8A is a perspective view of a fixed-angle adapter, according to a seventh embodiment of the present invention.

FIG. 8B is a cross-sectional view of the fixed-angle adapter of FIG. 8A.

FIG. 9A is a first cross-sectional view of a fixed-angle adapter, according to an eighth embodiment of the present invention.

FIG. 9B is a second cross-sectional view of the fixed-angle adapter of FIG. 9A.

FIG. 10A is a first perspective view of a fixed-angle adapter of the present invention relative to a workpiece.

FIG. 10B is a second perspective view of the fixed-angle adapter and workpiece of FIG. 10A.

FIG. 11A is a perspective view of a fixed-angle adapter and a standard swivel adapter relative to a workpiece.

FIG. 11B is a second perspective view of the fixed-angle adapter, standard swivel and workpiece of FIG. 11A.

FIG. 12A is a perspective view of a fixed-angle adapter and an impact swivel adapter relative to a workpiece.

FIG. 12B is a second perspective view of the fixed-angle adapter, impact swivel and workpiece of FIG. 12A.

FIGS. 13A-13K are line drawing views of a fixed angle adapter, according to a ninth embodiment of the present invention.

FIGS. 13L-13T are renderings of the fixed angle adapter of FIGS. 13A-13K.

### DETAILED DESCRIPTION OF THE INVENTION

With reference to the drawings (in which similar parts utilize the same or similar reference numbers), a fixed-angle adapter 10, configured to be used a tool or wrench for removing or inserting fasteners (not shown) such as bolts, nuts or other types of rotary fasteners, in tight spots that are hard to reach with a standard tool, even with an extension. For instance, the fixed-angle adapter 10 may be used with a ratchet wrench and socket (with or without an extension) for removing or inserting bolts or nuts,

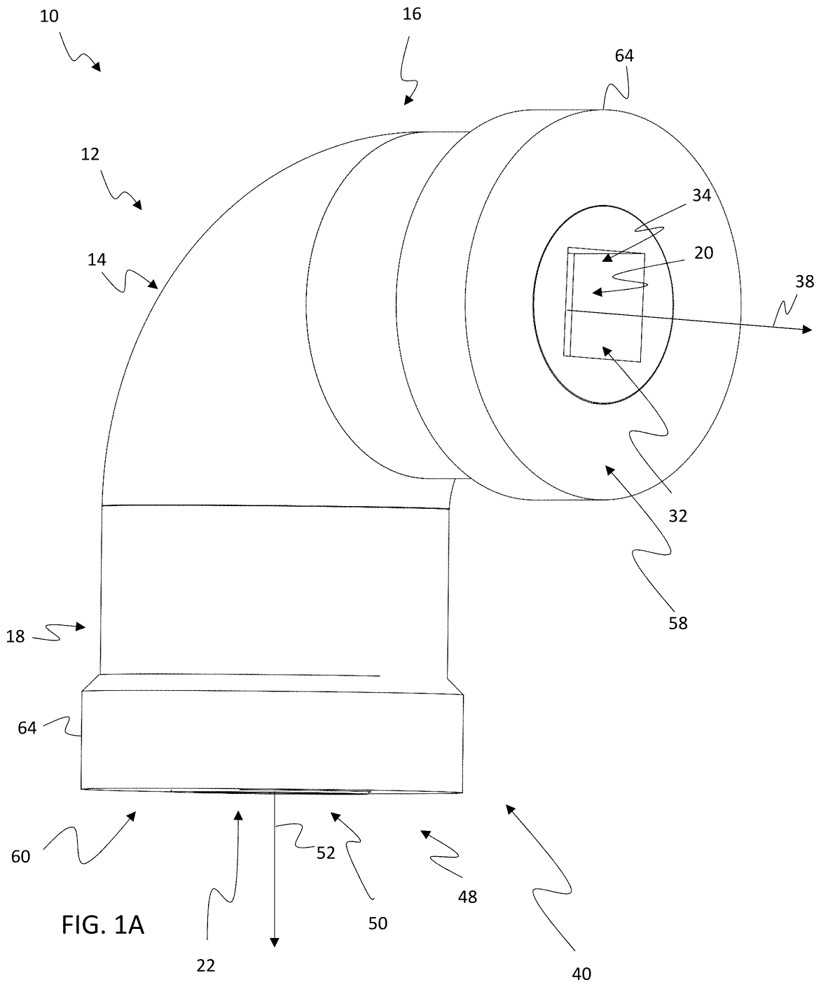

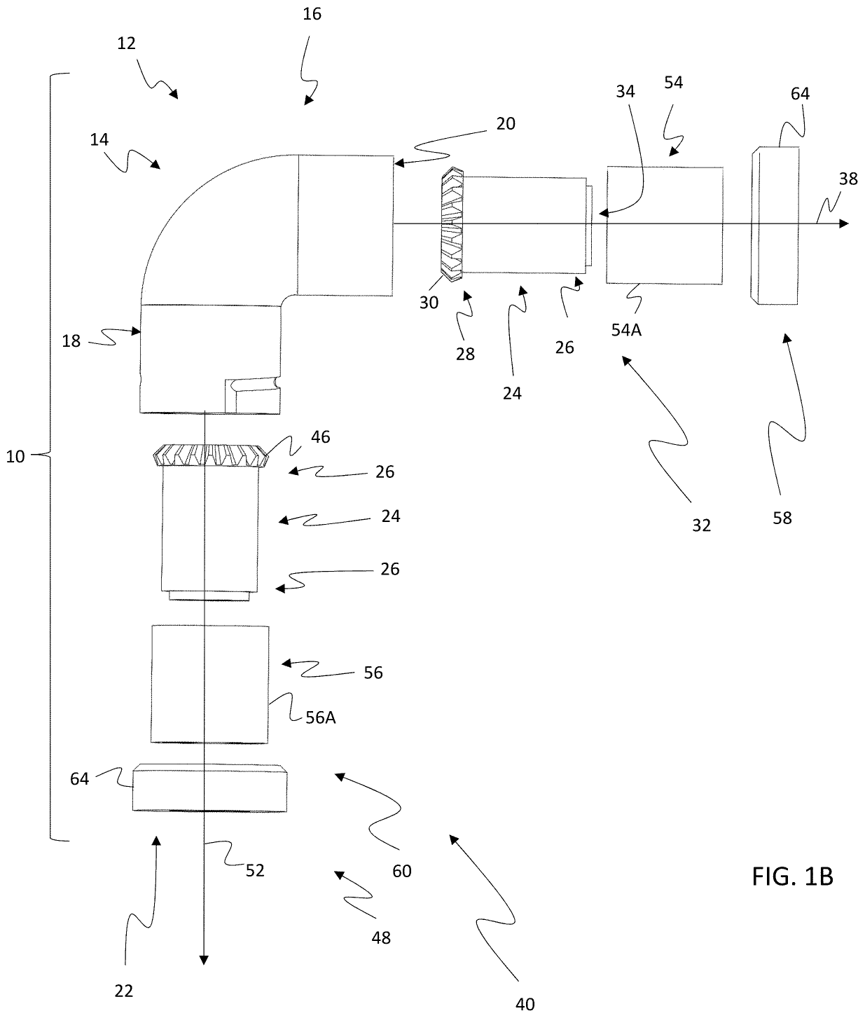

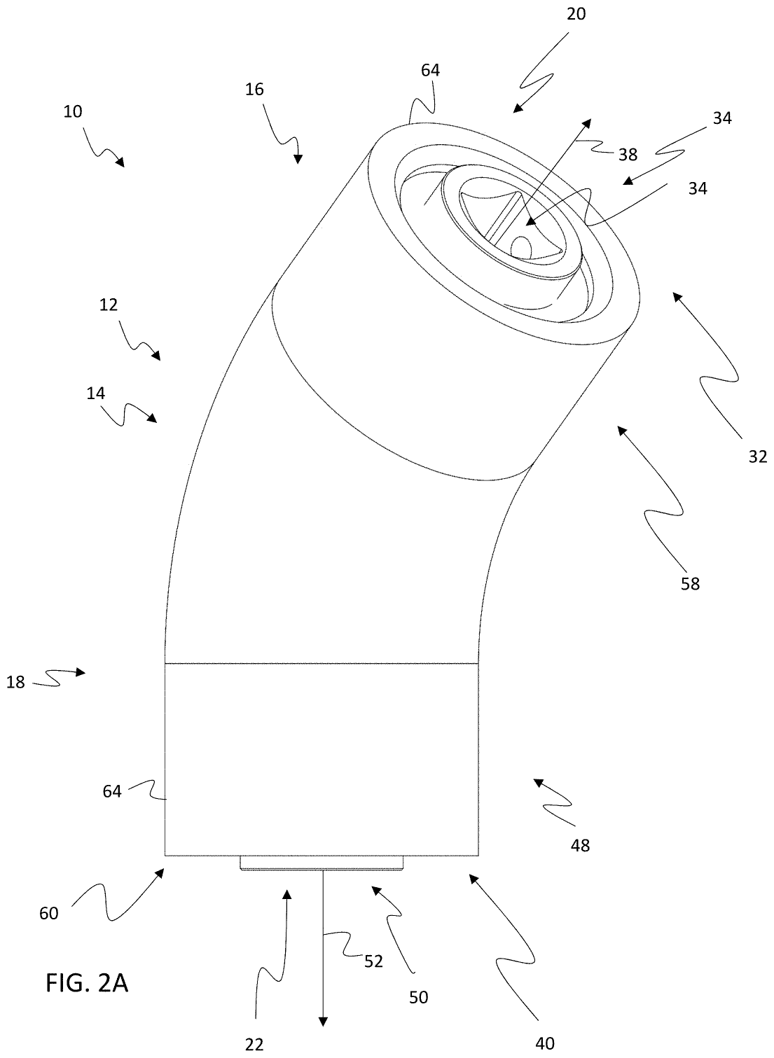

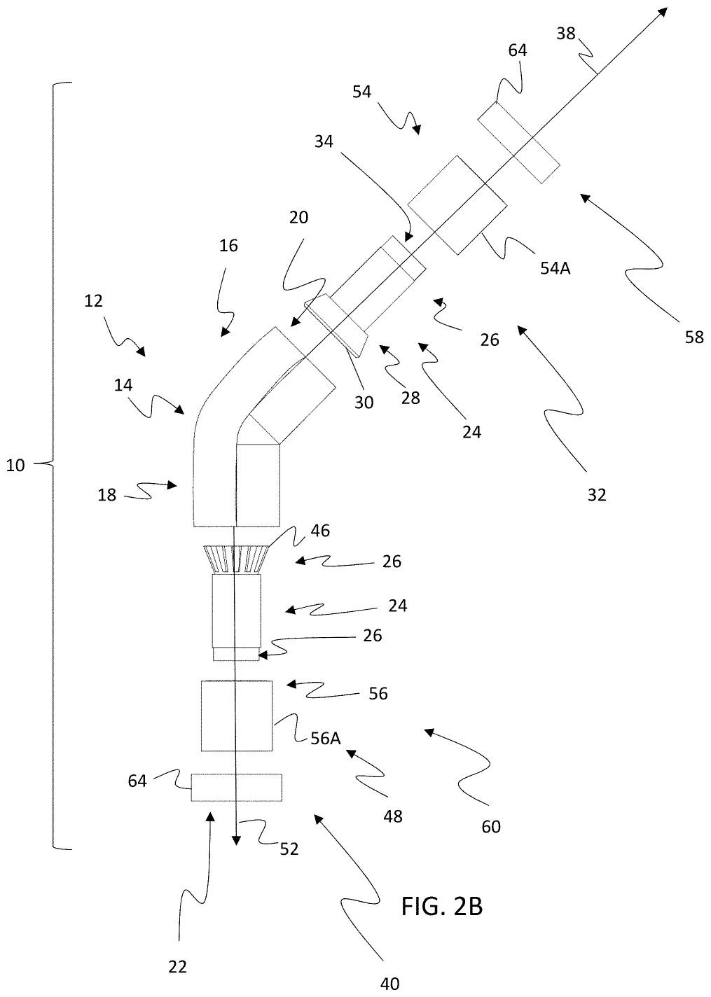

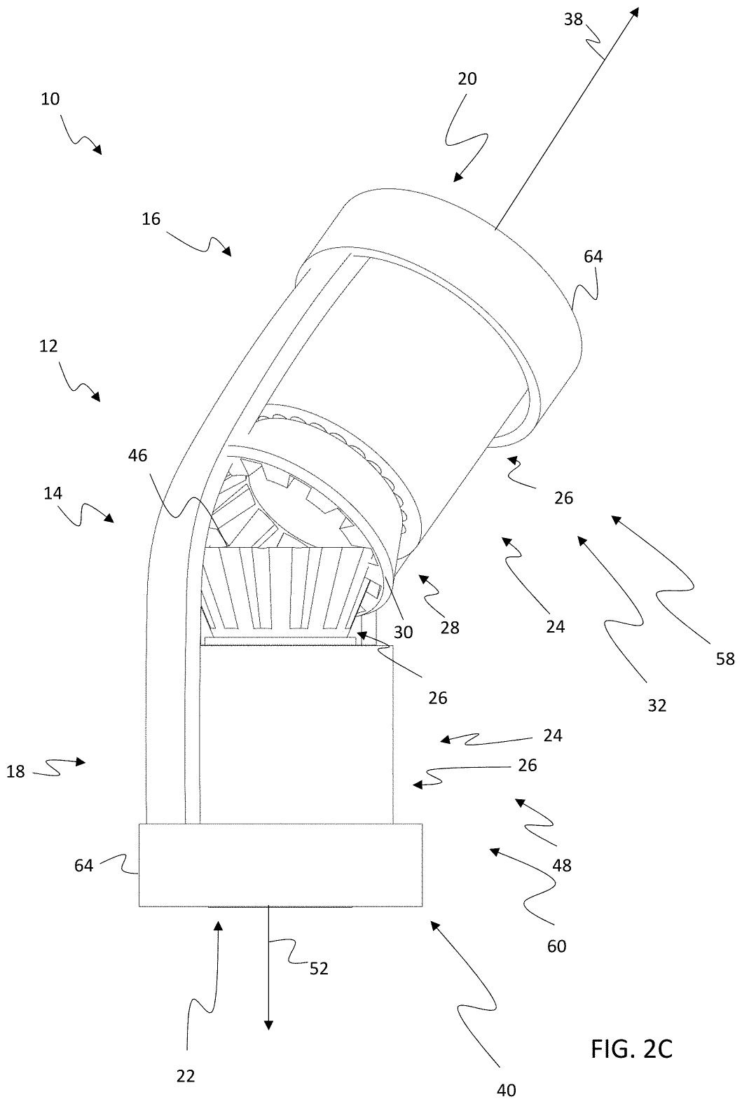

With specific reference to FIGS. 1-2, a fixed-angle adapter 10 according to a first embodiment is shown. The fixed-angle adapter 10 of FIGS. 1-2 includes a housing 12, a first gear 20, and a second gear 36. The housing 12 includes a central portion 14 and first and second end portions 16, 18. As shown, the first and second end portions 16, 18 extend from opposite ends of the central portion 14. The central portion 14 and the first end portion 16 form a first gear cavity 20 and the central portion 14 and the second end portion 18 form a second gear cavity 22. The first gear cavity 20 has, or defines, a first gear axis 34. The second gear cavity 22 has, or defines, a second gear axis 52. In the illustrated embodiment, the first and second gear axis 34, 52 are planar and at a predetermined angle. In the first embodiment of FIGS. 1-2, the predetermined angle is 90 degrees. In other embodiments, the predetermined angle may a different angle, e.g., 45 degrees.

As shown, the first gear 24 is located within the first gear cavity 20 and is allowed to rotate about the first gear axis 38. The second gear 40 is located within the second gear cavity 22 and is allowed to rotate about the second gear axis 52. The first and second gears 22, 40 form a bevel gear set. In the illustrated embodiment, the first and second gears 22, 40 are straight bevel gears with teeth (see below) that are in a straight line that intersects at the respective axis 38, 52. generally, the teeth of straight bevel gears are tapered in thickness, making the outer, or heel part of the tooth larger than the inner part, or toe. It should be noted that other types of bevel gears may also be used, for example, spiral or Zerol bevel gears.

The teeth 62 of the first and second gears 24, 40 intersect such that rotation of one of the first and second gears about a respective one of the first and second gear axis 38, 52 results in rotation of the other one of the first and second gears 22, 40 about the other one of the first and second gear axis 38, 52. In the illustrated embodiments, the housing 10 is composed from any suitable material or metal such as aluminum or an aluminum alloy. For example, the housing 10 may be composed from an aluminum alloy containing magnesium and silicon such as 6061 aluminum. In the illustrated embodiments, the first and second gears 24, 40 may be composed from steel, such as a steel alloy containing chromium and molybdenum, such as 4140 carbon steel.

Each of the first and second gears 24, 40 includes a shaft 26, 42 and a gear section 28, 44. As shown, the gear section 28, 44 of the each of the first and second gears 24, 40 having a plurality of teeth 62 extending therefrom. As shown, the fixed-angle adapter 10 may include first and second rotary members 54, 56. The first and second rotary members 54, 56 are generally cylindrical and are positioned over the shafts 26, 42 of the first and second gears 24, 40 respectively. The sleeves 54, 56 assisting in positioning and/or rotation of the first and second gears 24, 40 within the respective gear cavity 20, 22. The first and second rotary members 54, 56 may include bearings (see below) or sleeves 54A, 56A (as shown in FIGS. 1B). The sleeves 54A, 54B may composed be from any suitable material, such as steel or plastic.

As shown, the gear section 28, 44 may be cone-shaped, but it should be noted that other bevel gear configurations may be utilized. For example, in the embodiment shown in FIGS. 2A-2B, a bevel gear set in which one of the one of the gear sections is an inverse cone and the other one of the gear sections is an upside-down cone may be used.

The fixed-axis adapter 10 may also include a first retention mechanism 58 and a second retention mechanism 60 configured to retain the first gear 24 (and first sleeve 54) and the second gear 26 (and second sleeve 56) in the first and second cavities 20, 22, respectively. In the illustrated embodiment, the first and second retention mechanisms 58, 60 include caps 64 that are fixed or attached to the respective first and second end portions 16, 18 of the housing 12. The caps 40 may be threaded onto the first and second end portions 16, 18 and/or attached by suitable fasteners or clips (see below).

Each of the shafts 26, 42 includes an outer end 66 and a coupling mechanism 32, 48 affixed or located at each outer end 66. In the illustrated embodiment, the coupling mechanism 32, 48 affixed to each outer end 66 includes a square aperture 34, 50. The square aperture 34, 50 is sized, for example, 1/2 inch or 3/4 inch, to receive a standard drive stud (from a wrench, driver or extension). In use, one end of the adapter 10 may be driven or rotated using the drive stud from the wrench, driver or extension. The other end of the adapter 10 may be used to drive or rotate a socket (without or without an extender or another adapter tool, see below). A male-to-male adapter may be positioned within the aperture 34, 50 of the other end of the adapter 10 in order to drive the socket, extender or adapter tool, Alternatively, one of the first and second shafts 26, 42 may include a drive stud fixedly attached, or integrally formed therewith.

With reference to FIGS. 2A-2B, in a second embodiment a fixed-angle adapter 10 with a predetermined angle of 45 degrees (between the first and second gear axis 38, 52) is shown. In this embodiment, as shown, the first gear 24 has a gear section 28 in the shape of an inverse cone and the second gear 40 has a gear section 44 in the shape of an upside-down cone.

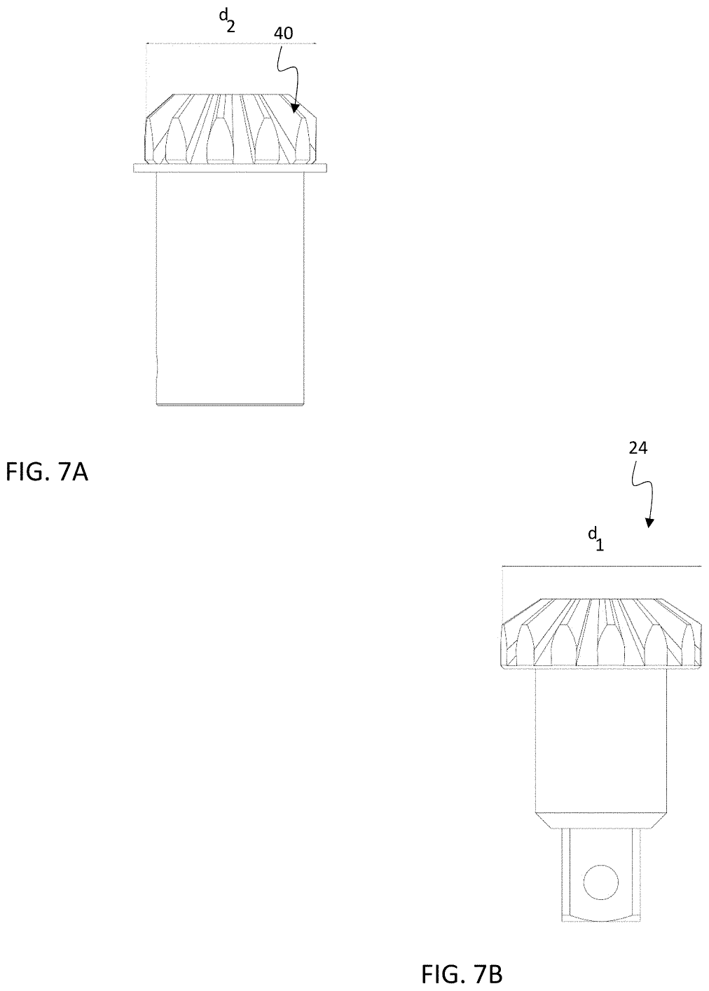

In one aspect of the present invention, the first and second gears 24, 40 are configured to provide increase torque to the first gear 24. Thus, the second gear 40 may be known as the drive gear and the first gear 24 as the driven gear. For example, in the illustrated embodiment shown in FIGS. 7A and 7B, the drive gear 40 has a smaller diameter, d₂, than the diameter, d₁, of the driven gear 24 and the less teeth 62.

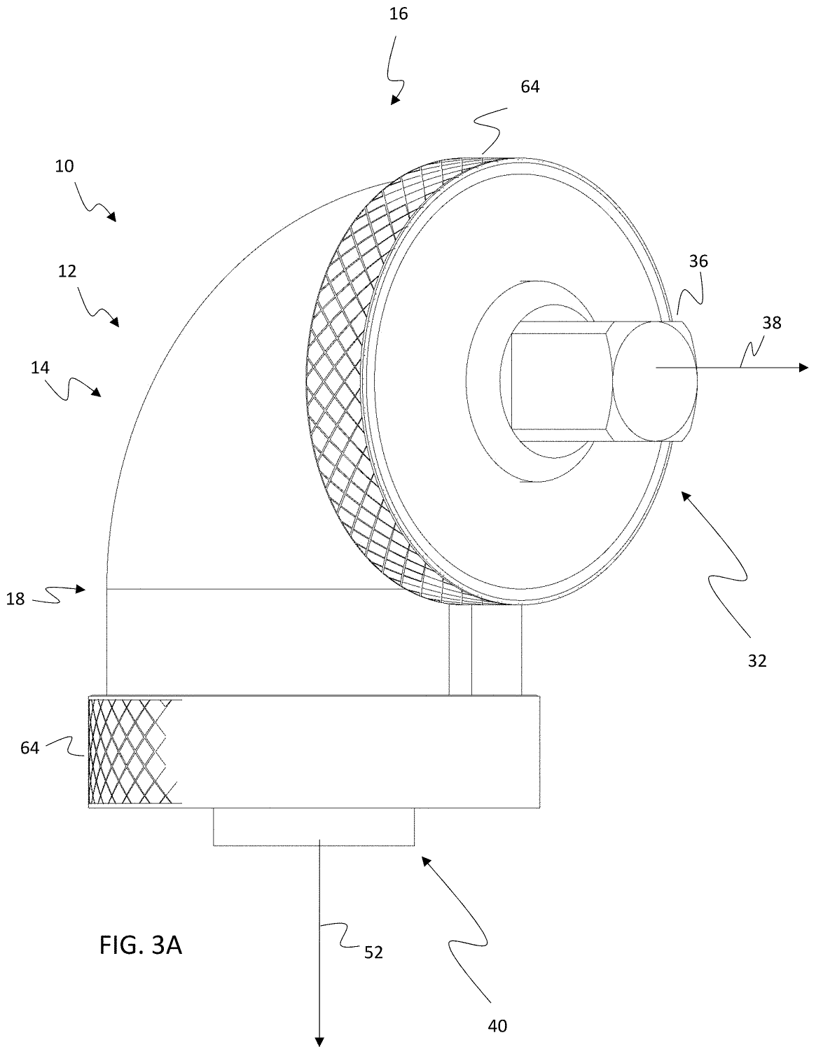

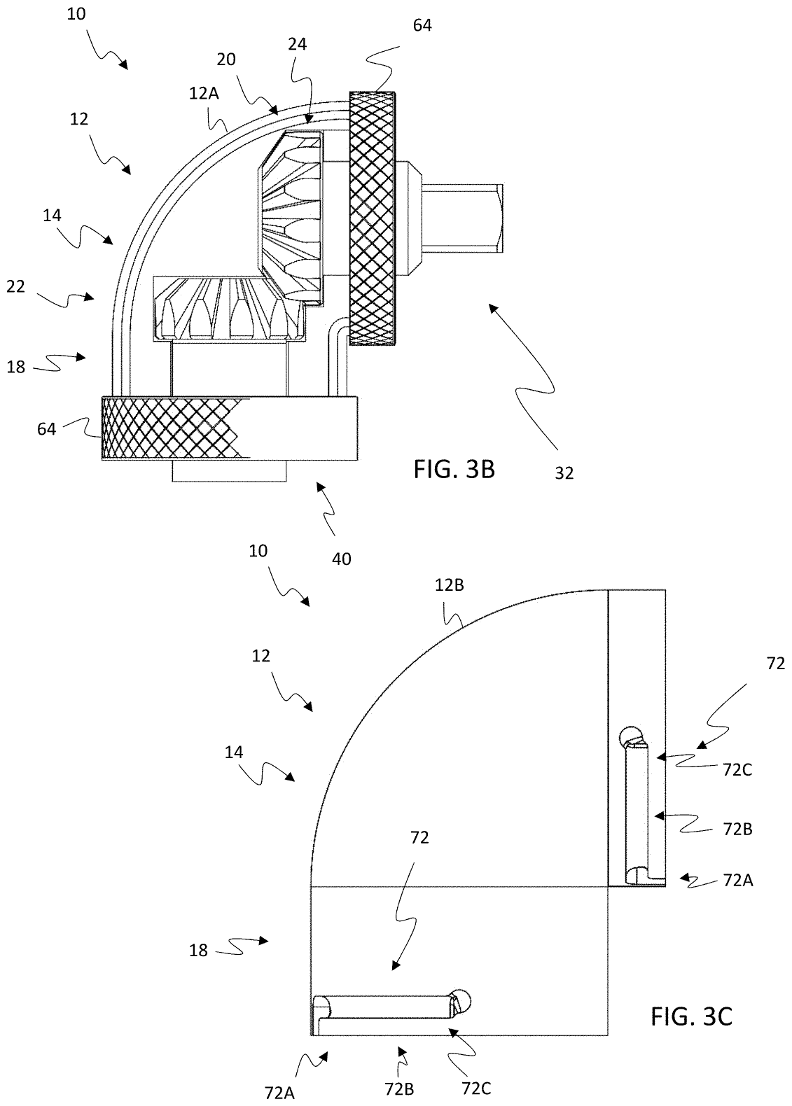

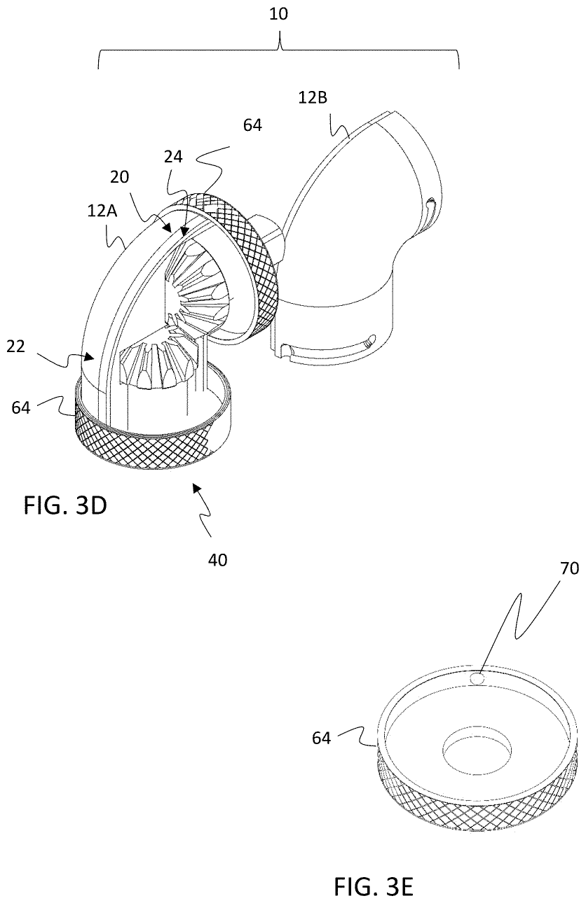

A third embodiment of the fixed-angle adapter 10 is shown FIGS. 3A-3B. In the third embodiment, the housing 12 includes a first portion 12A and a second portion 12B. The first and second gear cavities 20, 22 are formed to tightly fit the first and second gears 22, 24, and thus, the first and second housing portions 12A, 12B are assembled about the first and second gears 22, 24 and held together by the caps 64. In the illustrated embodiment, the caps 64 are attached to the respective one of the first and second end potions 16, 18 of the housing 12 via the respective retention mechanisms 58, 60. The first and second retention mechanisms 58, 60 include one or more embedded spheres 70 on an inner surface of the caps 64. Each of the first and second end portions 16, 18 has one or more indented tracks 72 on an outer surface thereof. The indented tracks 72 have an opening 70A at one end for receiving the embedded spheres 70, a central portion 70B and a detent position 70C. To assemble, the caps 64 to the end positions 16, 18, the embedded spheres 70 are lined up with the opening 70A and then pushed on. The caps 64 may be turned (with the embedded spheres 70 traveling within the central portions 70B until the embedded sphere 70 lock into the detent positions 70C.

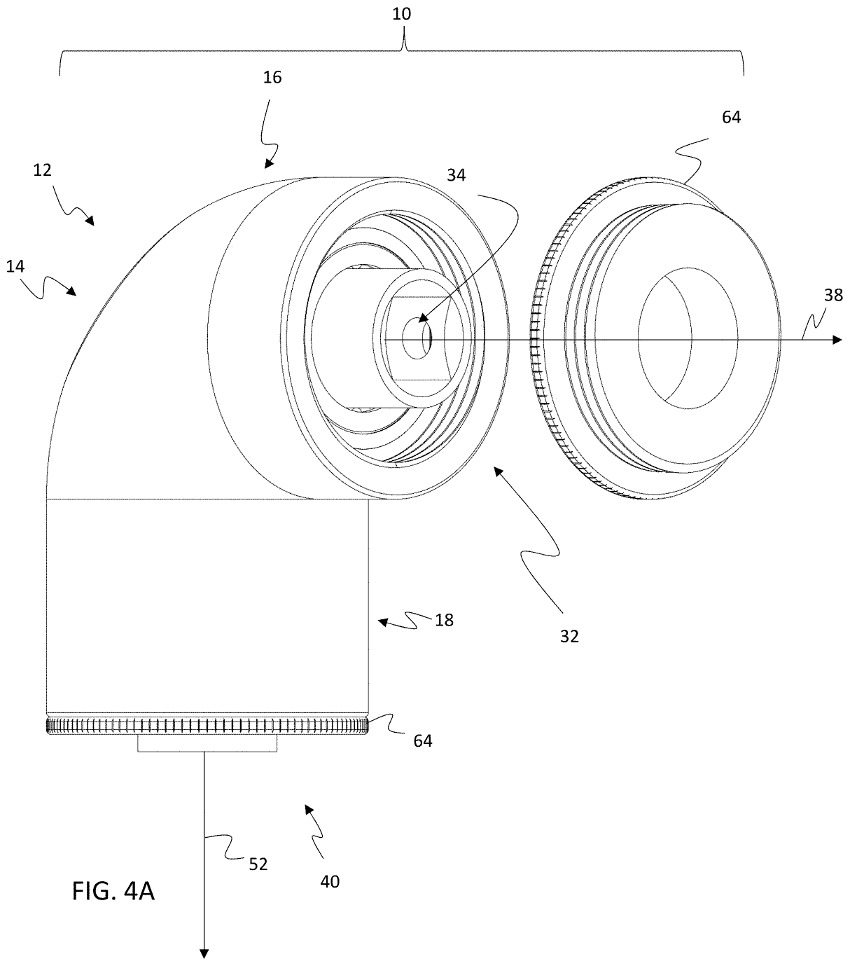

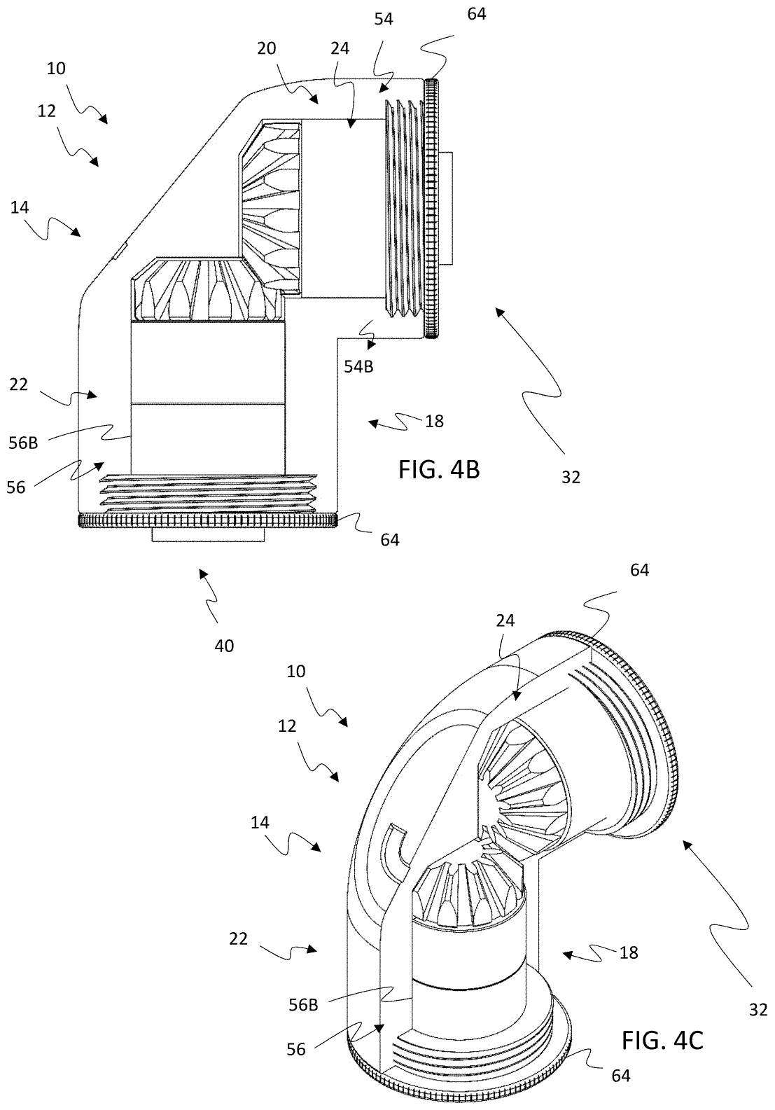

With reference to FIGS. 4A-4C, in a fourth embodiment, the caps 64 have an end portion 64A and inner portion 64B. The inner portion 64A of the caps 64 are threaded and an inner portion of the first and second end portions 14, 16 of the housing 12 includes complimentary threads to allow the caps 64 to be screwed onto the first and second end portions 14, 16 of the housing, respectively. As shown, an outer surface of the end portions 64A of the caps 64 may to textured to provide better grip. As shown, in the fourth embodiment, the first and second rotary members 54, 56 are bearings 54B, 56B, such as needle bearings (as shown) or ball bearings or the like.

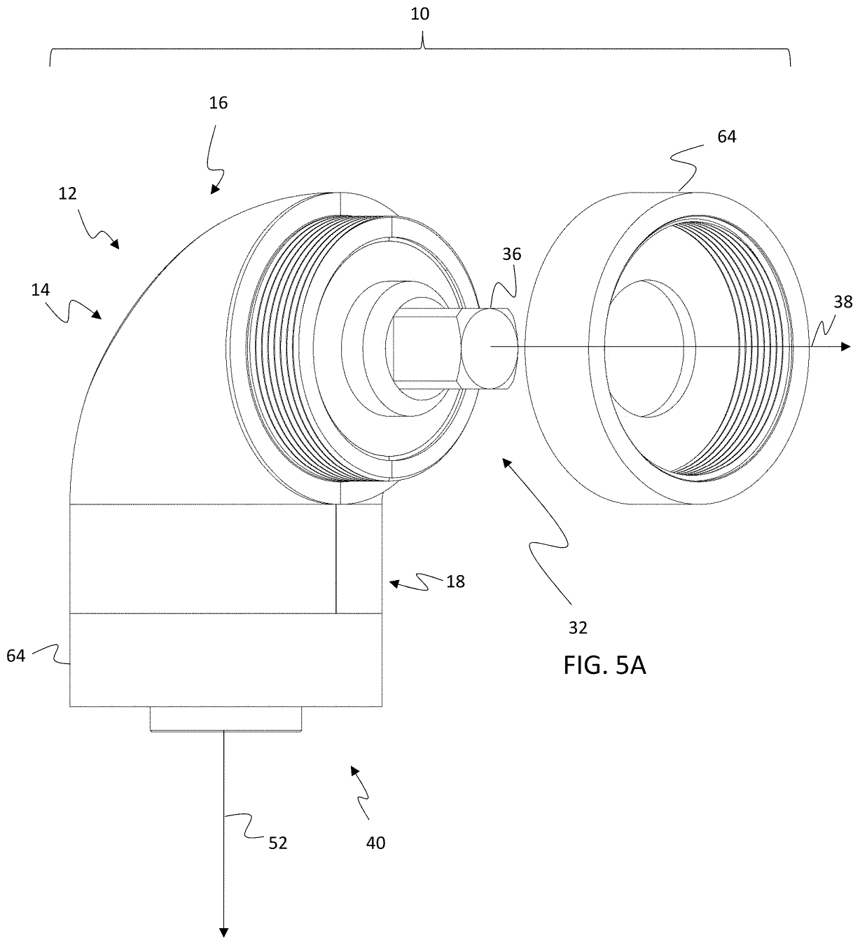

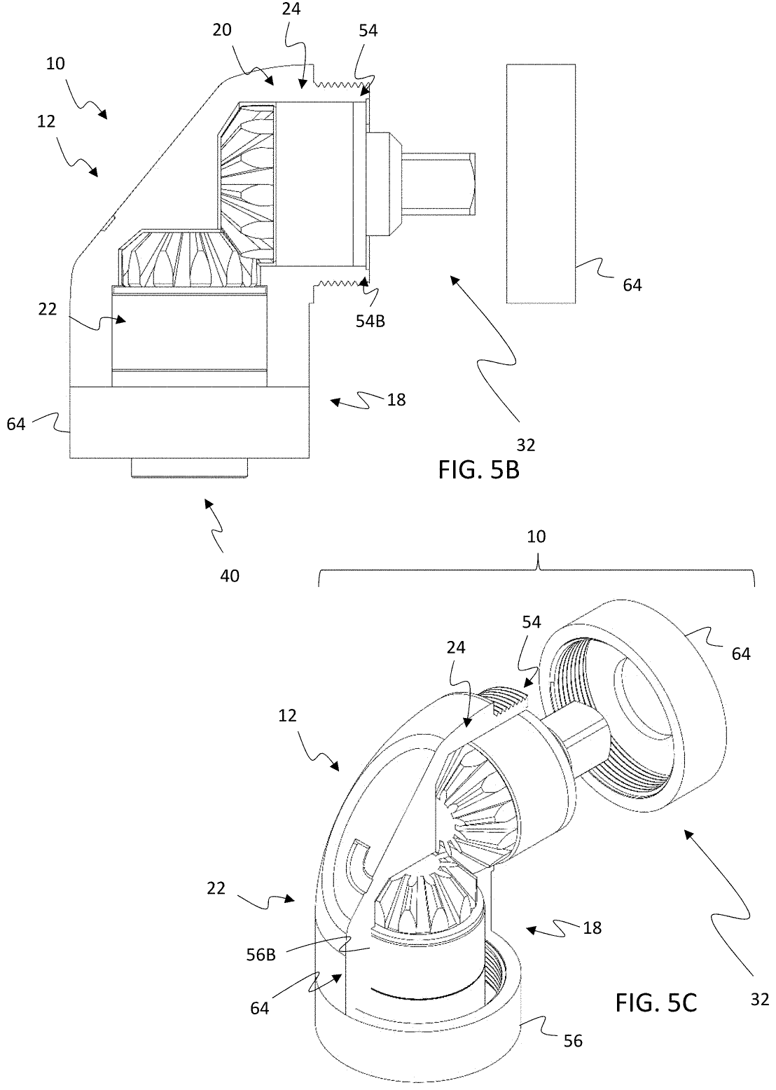

With reference to FIGS. 5A-5C, in a fifth embodiment, the caps 64 define a circular channel 64C. An inner surface of the channel 64C of the caps 64 may be threaded and an outer surface of the first and second end portions 14, 16 of the housing 12 may include complimentary threads to allow the caps 64 to be screwed onto the first and second end portions 14, 16 of the housing, respectively. Although not shown, an outer surface of the caps 64 may to textured to provide better grip. Further, in the illustrated embodiment, the first rotary member 54 includes a ball bearing 54B and the second rotary member 56 includes a needle bearing 56B.

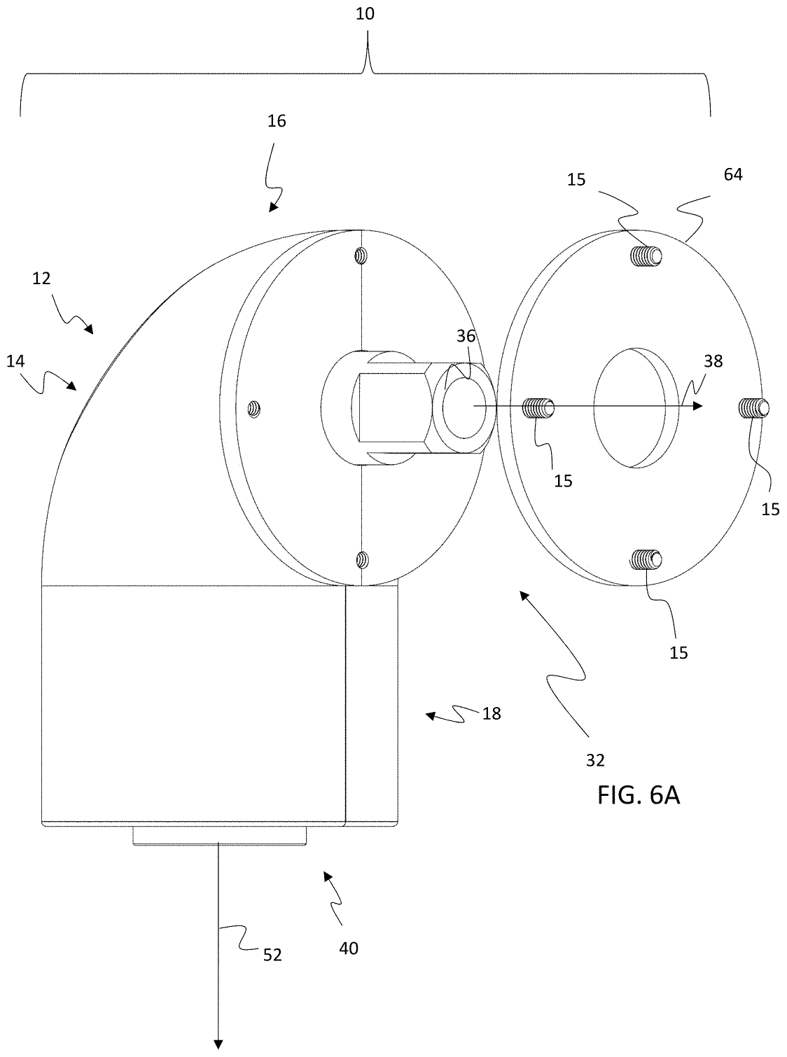

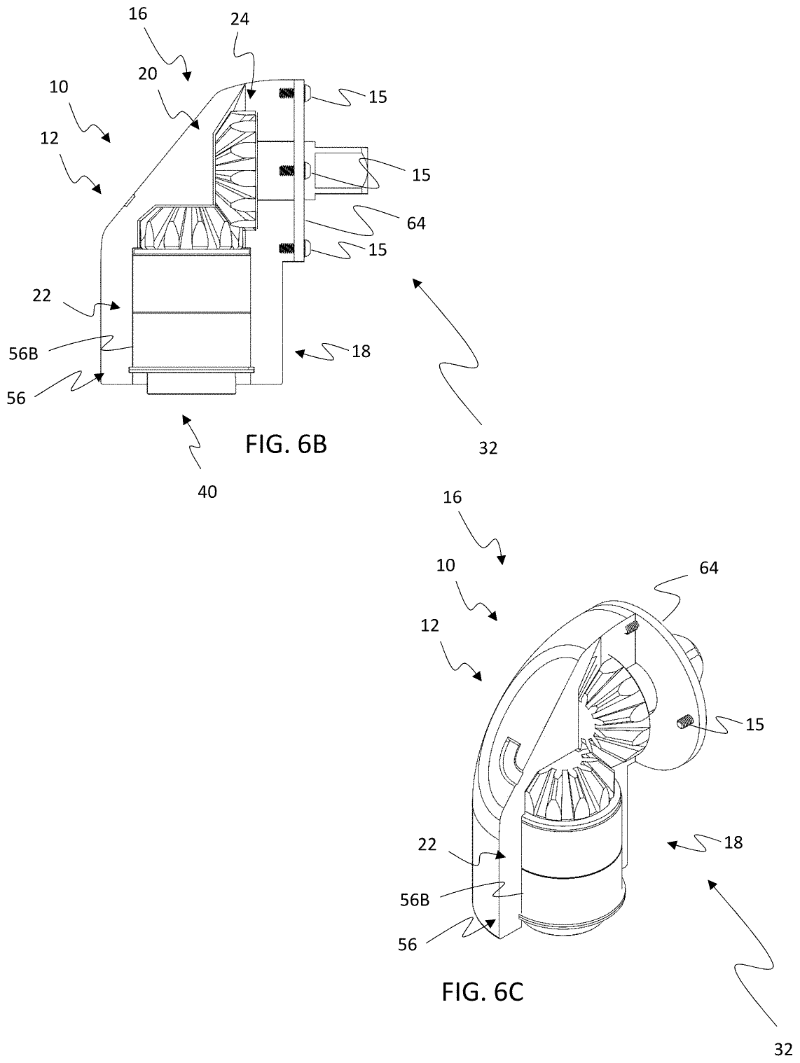

With reference to FIGS. 6A-6C, in a sixth embodiment, the fixed angle adapter 10 includes a first cap 64A that is affixed the first end portion 16 of the housing 12 via a plurality of fasteners 15. The fixed angle adapter 10 includes a second rotary member 56 shown as a bearing 56B. A rotary clip 74 positioned with a receiving channel 76 in an inner surface of the second end portion 18 of the housing 12, as shown. The rotary clip 74 holds the second gear 40 and bearing 56B within the second gear cavity 22.

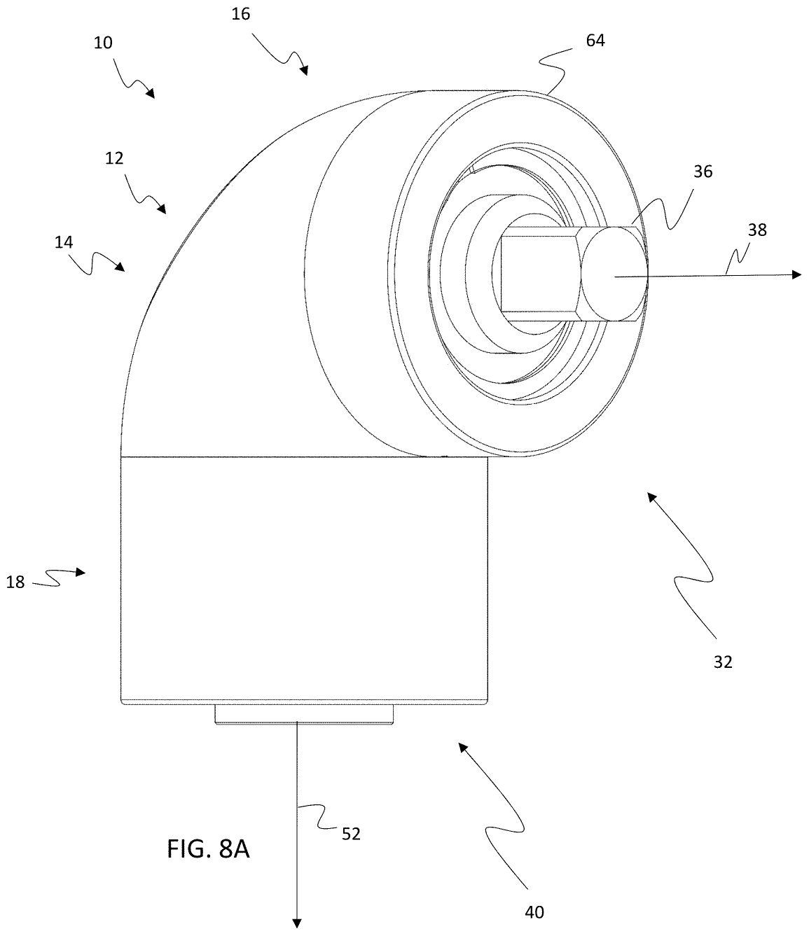

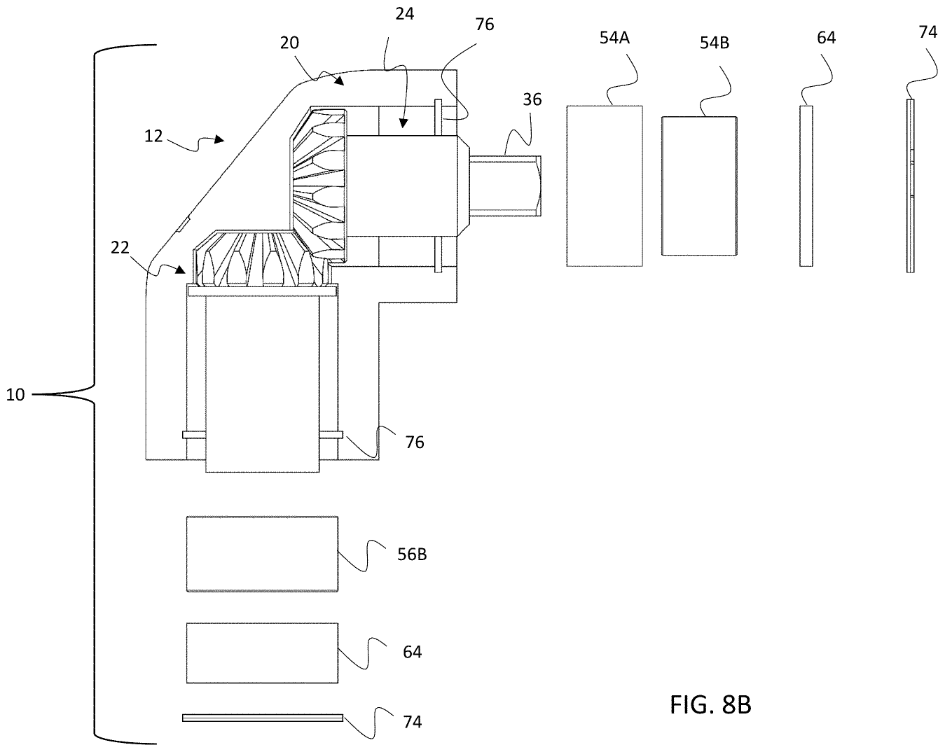

With reference to FIGS. 8A-8B, in a seventh embodiment, the fixed angle adapter 10 includes a pair of caps 64 affixed to relative end portion 16, 18 of the housing 12 via a plurality of rotary clips 74 located within channels 76 on the inner surface of the respective end portion 16, 18 of the housing 12. The fixed angle adapter 10 includes a first and second rotary members 54, 56 including bearing 54B, 56B. The first rotary member 54 also includes a sleeve 54A. The sleeve 54A fits over the bearing 54B to keep the bearing 54B tight against the housing 12. The rotary clips 74 hold the first gear 24, sleeve 54A, and bearing 54B within the first gear cavity 20 and the second gear 40 and bearing 56B within the second gear cavity 22. In the illustrated embodiment, the bearings 54B, 56B are needle bearings.

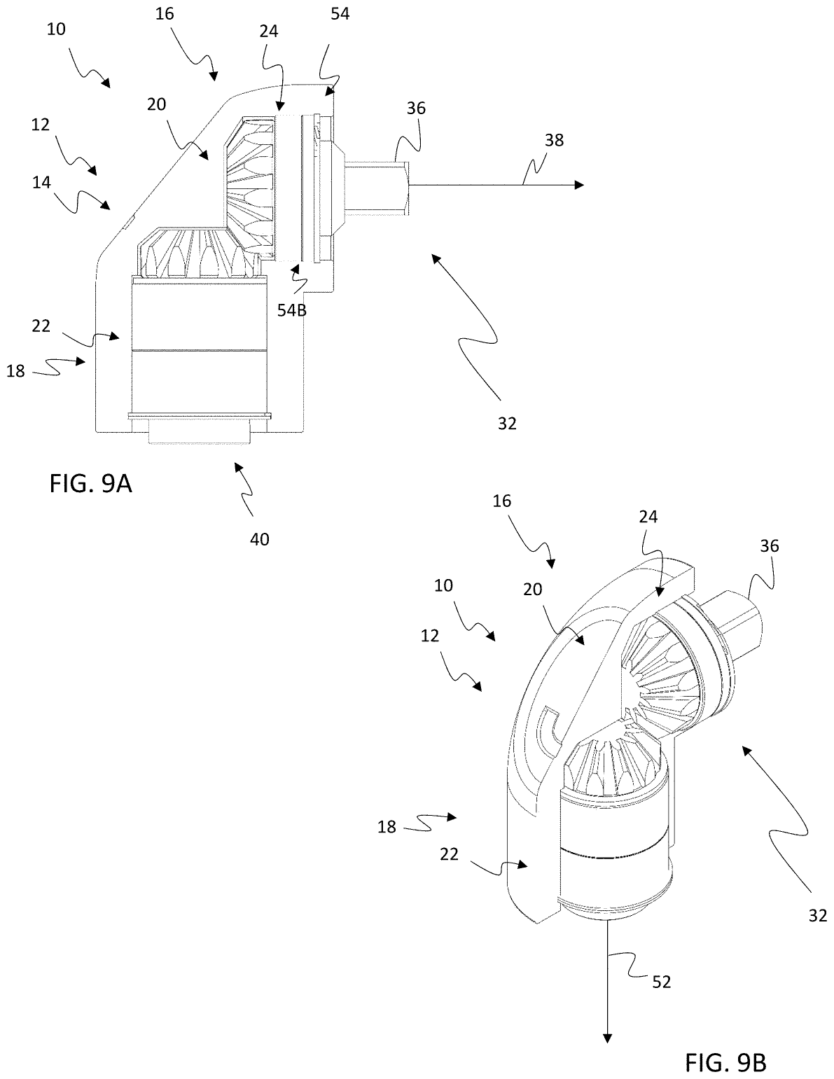

With reference to FIGS. 9A-9B, in an eighth embodiment, the fixed angle adapter 10 is similar to the fixed angle adapter 10 of the fifth embodiment shown in FIGS. 8A-8B. However, needle bearing 54B has been replaced with a ball bearing (which has a shorter profile). As discussed above, in one aspect of the present invention, the fixed-angle adapter 10 may be configured to provide increased torque to the first gear 24. Thus, the adapter 10 should only be driven via the second gear 40. As shown, the second end portion 18 of the housing 12 is longer than the first end portion 16 (in the third through sixth embodiments) to help distinguish (to the user) the driving end of the adapter 10).

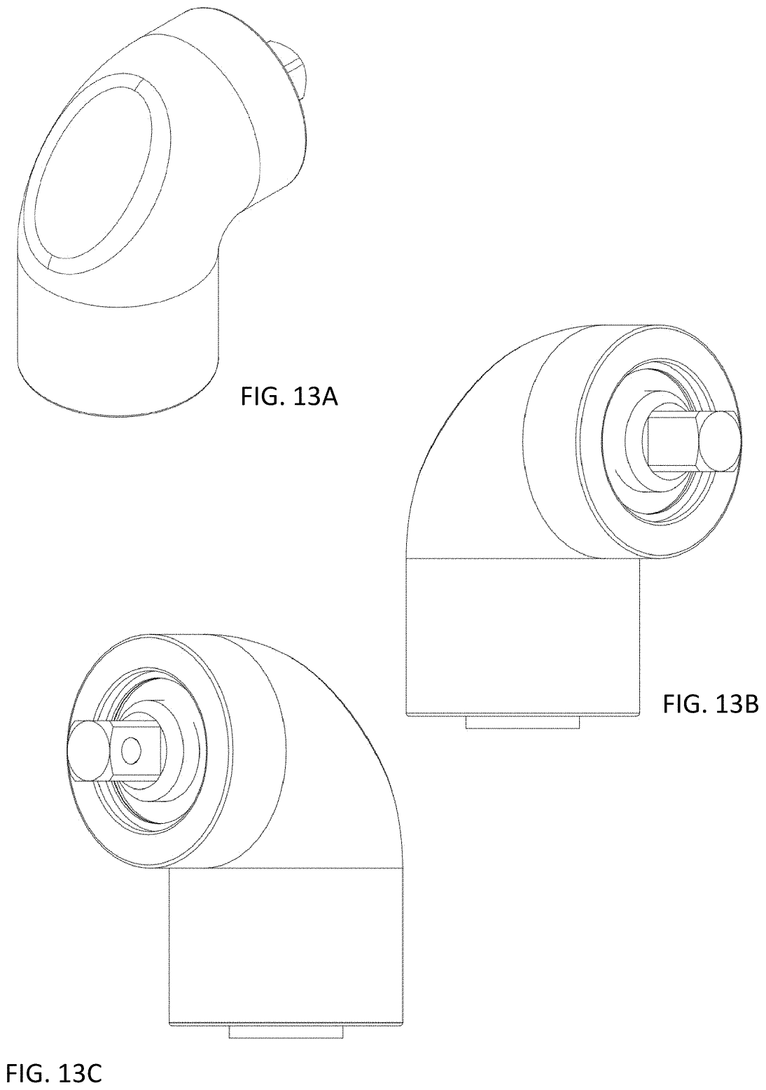

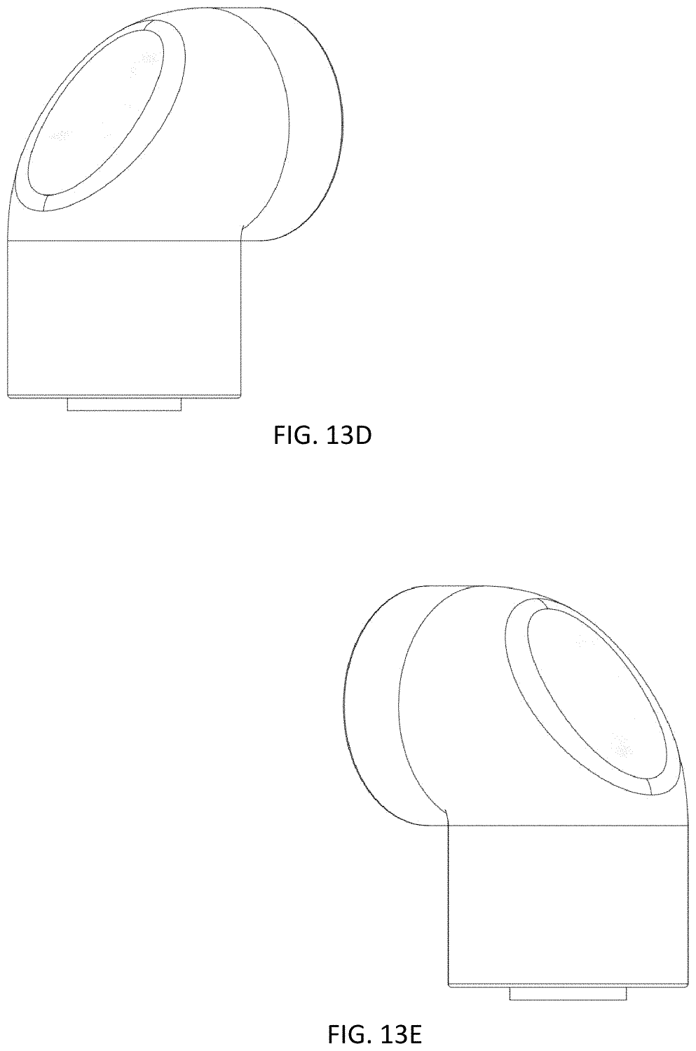

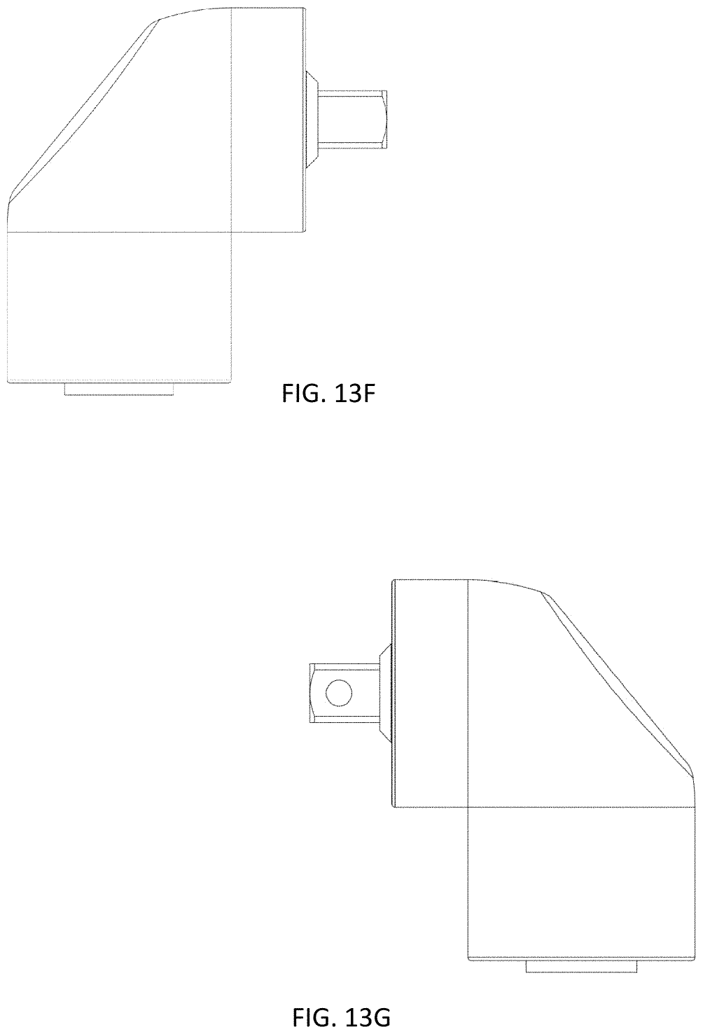

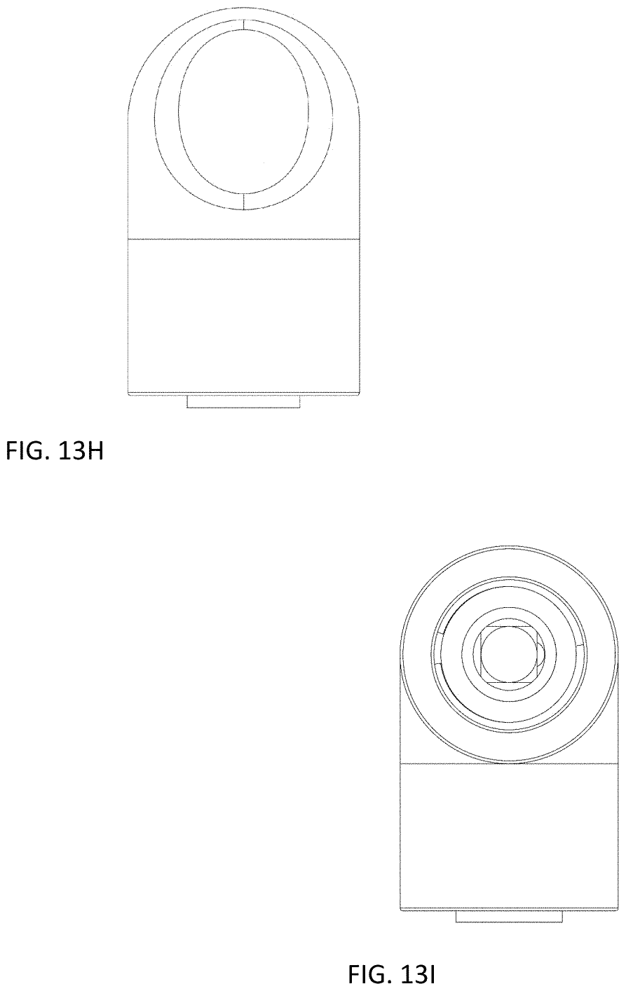

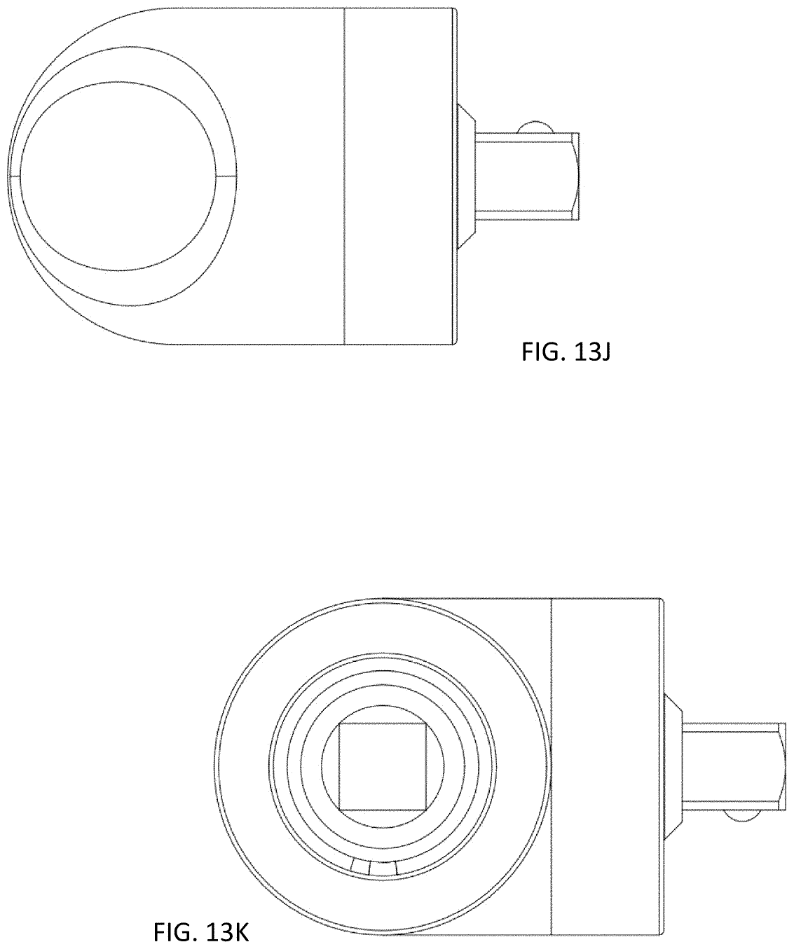

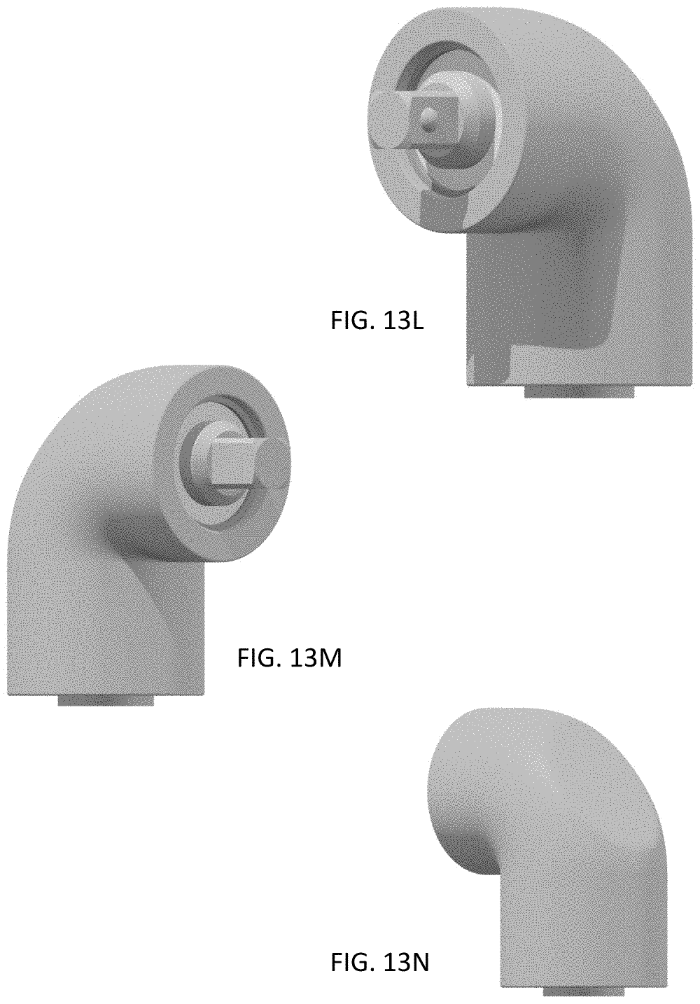

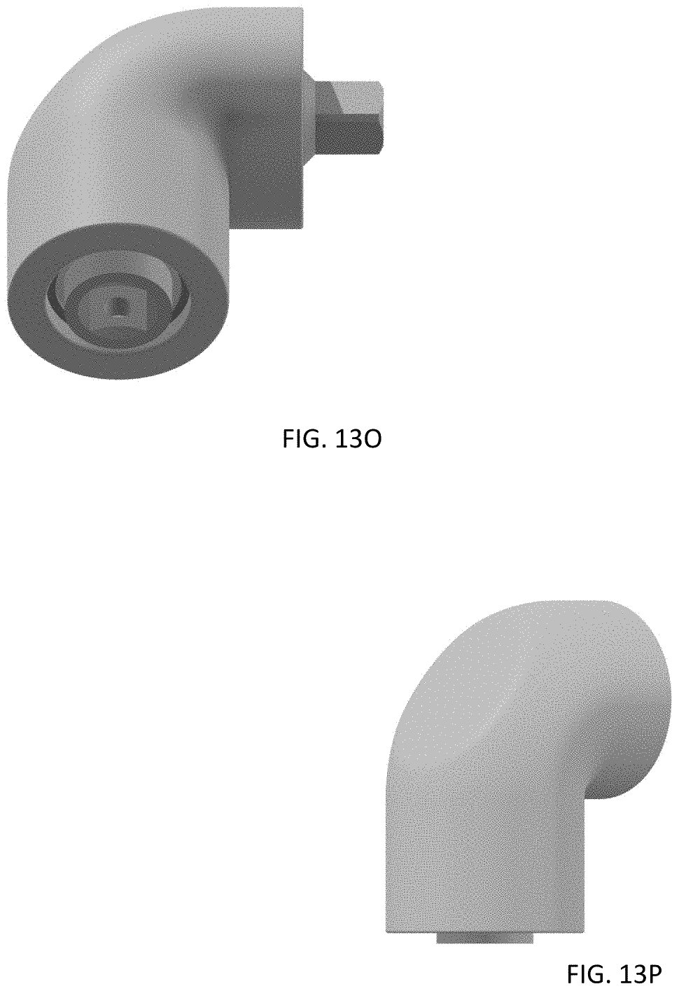

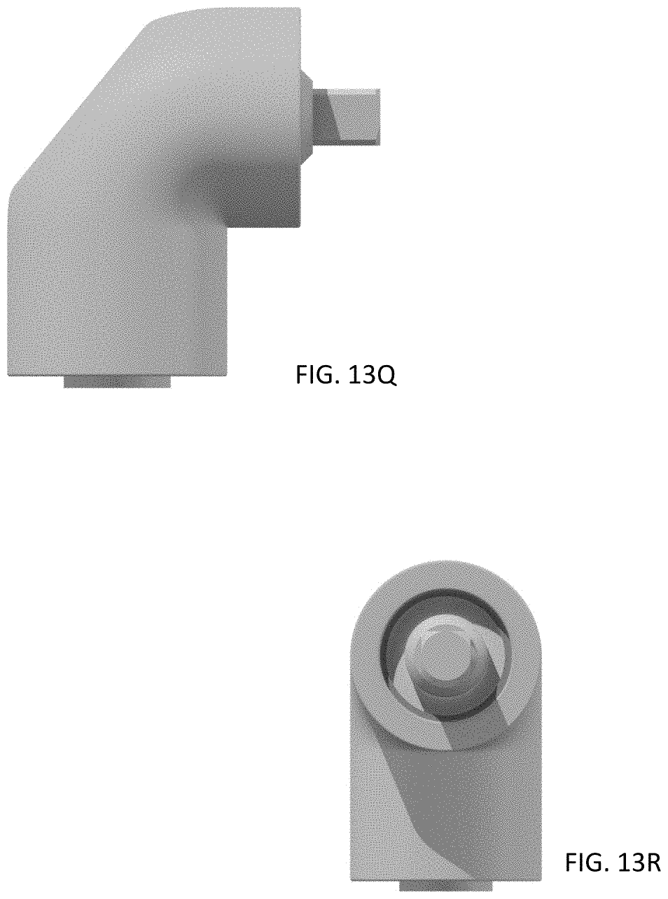

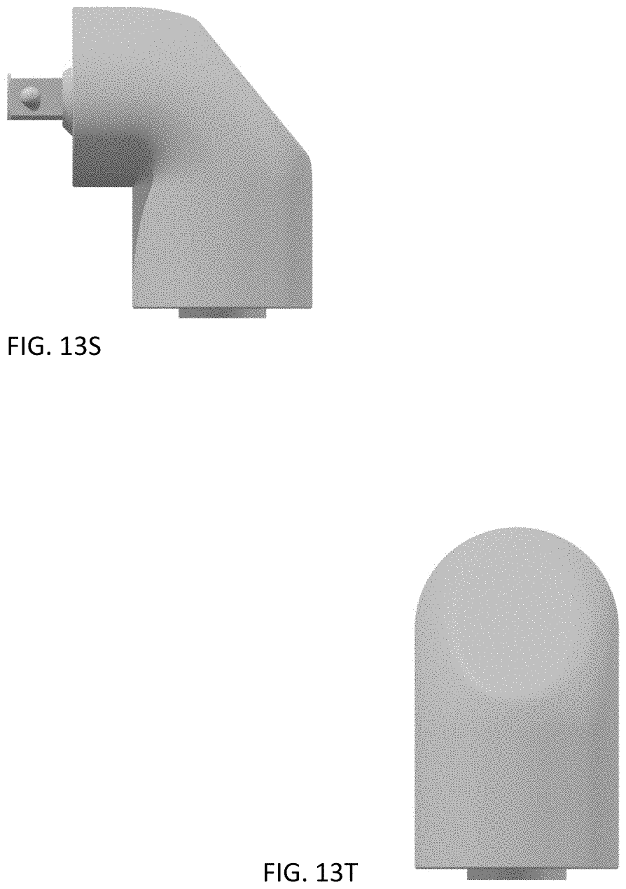

A fixed angle adapter according to a ninth embodiment is shown in FIGS. 13A-13T.

### INDUSTRIAL APPLICABILITY

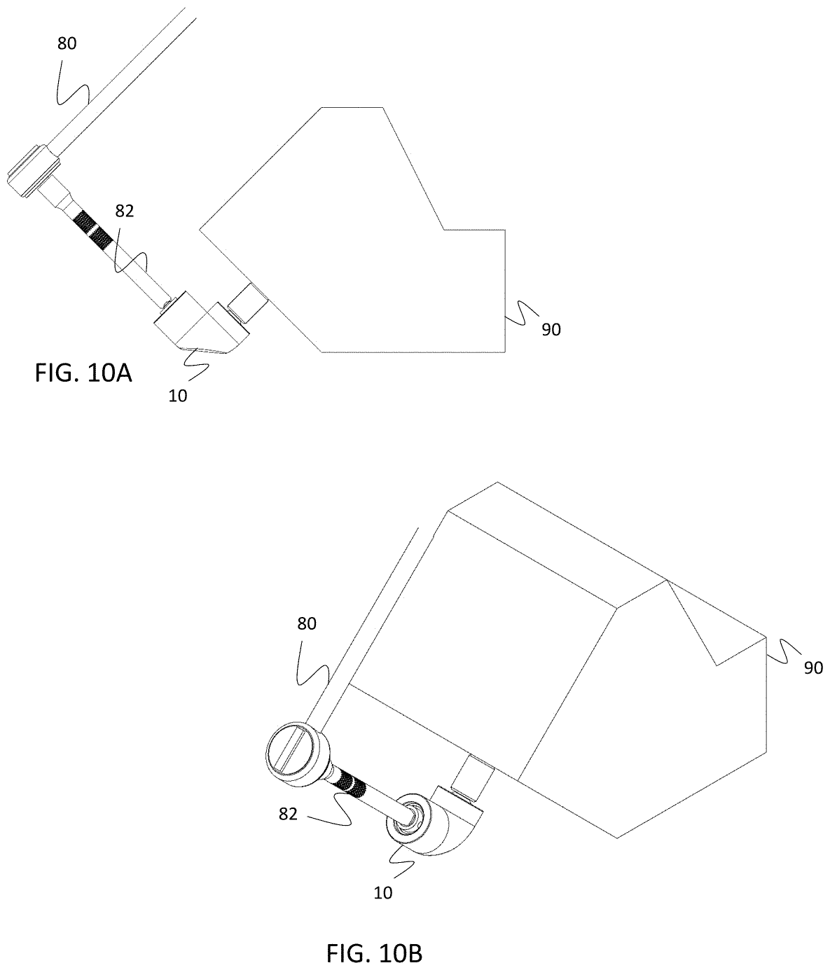

With reference to the drawings, and in operation, the present invention provides a fixed-angle adapter 10, configured to be used a tool or wrench for removing or inserting fasteners (not shown) such as bolts, nuts or other types of rotary fasteners, in tight spots that are hard to reach with a standard tool, even with an extension. As detailed above and with reference to FIGS. 10A-10B, the fixed-angle adapter 10 may be used to replace a standard swivel or universal adapter to reach fasteners in hard-to-reach places. As shown, the fixed angle adapter 10 may be used to reach a fastener (not shown) located on a workpiece 90 (that may be difficult to reach otherwise) using a standard ratchet wrench 80 and extension 82.

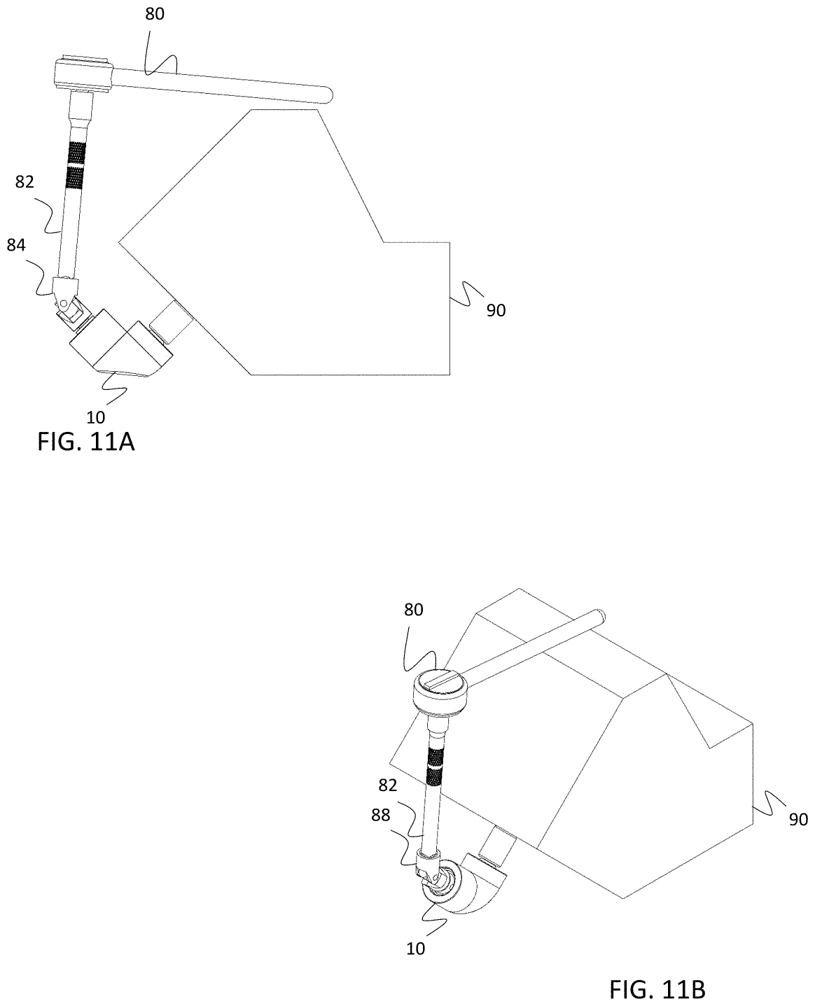

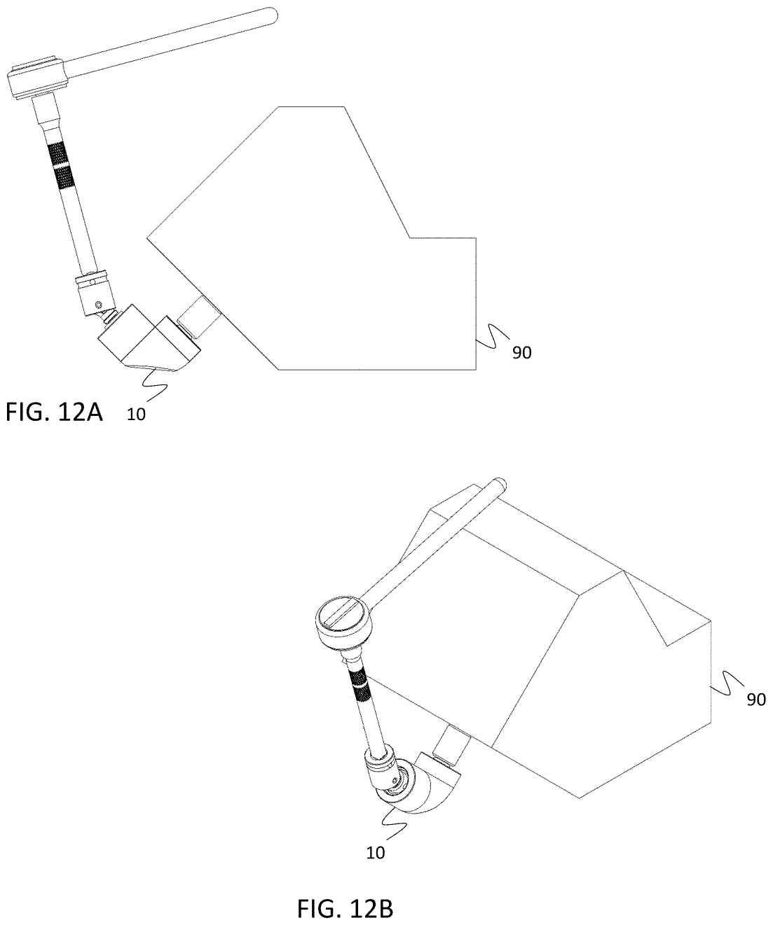

In addition, the fixed-angle adapter 10 may be used in conjunction with a standard swivel or universal adapter to remove or inserts bolts (or other fasteners) at extreme angles that would not be possible with either the fixed angle adapter 10 or a standard or universal adapter alone. For example, a fixed-angle adapter 10 may be attached to the end of a universal or standard adapter 84 (FIGS. 10A-10B) or an impact adapter 88 (FIGS. 11A-11B) or a to reach a fastener (via a socket 86) that is located at an extreme angle, and thus, hard to reach.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A fixed-angle adapter, comprising:
a housing having:
a central portion, and
first and second end portions extending from opposite end of the central portion, the first end portion and the central portion defining a first gear cavity, the first gear cavity having a first gear axis, the second end portion and the central portion defining a second gear cavity, the second gear cavity having a second gear axis, the first and second gear axis being planar, the second gear axis being at a predetermined angle relative to the first gear axis;
a first gear located within the first gear cavity and being allowed to rotate about the first gear axis; and,
a second gear located within the second gear cavity and being allowed to rotate about the second gear axis, the first and second gear intersect such that rotation of one of the first and second gears about a respective one of the first and second gear axis results in rotation of the other one of the first and second gears about the other one of the first and second gear axis, wherein the each of the first and second gears including a shaft and a gear section, each one of the shafts includes an outer end and a coupling mechanism affixed to the outer end.

2. The fixed-angle adapter, as set forth in claim 1, wherein the gear section is cone-shaped and includes a plurality of teeth located on the gear section.

3. The fixed-angle adapter, as set forth in claim 2, wherein one of the gear sections is an inverse cone and the other one of the gear sections is an upside-down cone.

4. The fixed-angle as set forth in claim 1, wherein at least one of the coupling mechanisms on the shafts of the first and second gears is an aperture and the other one of the coupling mechanisms is one of an aperture and a drive stud.

5. The fixed-angle adapter, as set forth in claim 1, further including a first retention mechanism and a second retention mechanism configured to retain the first gear and the second gear in the first and second cavities, respectively.

6. The fixed-angle adapter, as set forth in claim 5, wherein each of the first and second retention mechanisms includes a rotary member and a cap.

7. The fixed-angle adapter, as set forth in claim 6, wherein the rotary member is a sleeve.

8. The fixed-angle adapter, as set forth in claim 6, wherein the rotary member is a ball bearing.

9. The fixed-angle adapter, as set forth in claim 6, including first and second fastening mechanisms to affix the cap to the respective end portion of the housing.

10. The fixed-angle adapter, as set forth in claim 9, wherein the fastening mechanisms include a sphere embedded within an inner surface of each cap and an indented track on an outside surface of each end portion of the housing for receiving the embedded sphere of the respective cap.

11. The fixed-angle adapter, as set in claim 9, the fastening mechanism includes a clip associated with each end portion of the housing, each end portion of the housing having a notch located on an inside surface thereof for receiving a respective clip.

12. The fixed-angle adapter, as set forth in claim 9, wherein the fastening mechanism includes threads located on an outer surface of each end portion and complimentary threads on an inner surface of each cap.

13. The fixed-angle adapter, as set forth in claim 9, wherein the fastening mechanism includes a plurality of fasteners for affixing the caps to the housing.

14. The fixed-angle adapter, as set forth in claim 1, wherein the predetermined angle is 45 degrees.

15. The fixed-angle adapter, as set forth in claim 1, wherein the predetermined angle is 90 degrees.

16. A fixed-angle adapter, comprising:
a housing having:
a central portion, and
first and second end portions extending from opposite end of the central portion, the first end portion and the central portion defining a first gear cavity, the first gear cavity having a first gear axis, the second end portion and the central portion defining a second gear cavity, the second gear cavity having a second gear axis, the first and second gear axis being planar, the second gear axis being at a predetermined angle relative to the first gear axis;
a first gear located within the first gear cavity and being allowed to rotate about the first gear axis;
a second gear located within the second gear cavity and being allowed to rotate about the second gear axis, the first and second gear intersect such that rotation of one of the first and second gears about a respective one of the first and second gear axis results in rotation of the other one of the first and second gears about the other one of the first and second gear axis, wherein each of the first and second gears includes a shaft and a gear section, wherein the gear section is cone-shaped and includes a plurality of teeth located on the gear section, wherein each one of the shafts includes an outer end and a coupling mechanism affixed to the outer end, wherein at least one of the coupling mechanisms on the shafts of the first and second gears is an aperture and the other one of the coupling mechanisms is one of an aperture and a drive stud; and,
a first retention mechanism and a second retention mechanism configured to retain the first gear and the second gear in the first and second cavities, respectively.

17. The fixed-angle adapter, as set forth in claim 16, wherein the each of the first and second gears including a shaft and a gear section.

18. The fixed-angle adapter, as set forth in claim 17, wherein each one of the shafts includes an outer end and a coupling mechanism affixed to the outer end.

19. The fixed-angle adapter, as set forth in claim 18, wherein at least one of the coupling mechanisms on the shafts of the first and second gears is an aperture and the other one of the coupling mechanisms is one of an aperture and a drive stud.

20. The fixed-angle adapter, as set forth in claim 16, wherein the predetermined angle is one of 45 degrees and 90 degrees.
